(19) United States
(12) Patent Application Publication
(10) Pub. No.: US 2025/0040749 A1
(43) Pub. Date: Feb. 6, 2025

(54) Coffee Extracting Device

(71) Applicant: Zeroth Law, Inc., Seoul (KR)

(72) Inventors: Hyeong Jeon AN, Gyeonggi-do (KR); Junseon YOO, Seoul (KR); Hyunwoo NOH, Gyeonggi-do (KR)

(73) Assignee: Zeroth Law, Inc., Seoul (KR)

(21) Appl. No.: 18/716,078

(22) PCT Filed: Nov. 9, 2022
(86) PCT No.: PCT/KR2022/017496

§ 371 Date: Jun. 3, 2024

(30) Foreign Application Priority Data
Dec. 6, 2021 (KR) 10-2021-0172673
Apr. 14, 2022 (KR) 10-2022-0046090

(51) Int. Cl. A47J 31/52

(52) U.S. Cl. CPC A47J 31/521; A47J 31/5251

(57) ABSTRACT

Disclosed is a coffee extraction apparatus according to some embodiments of the present disclosure. The coffee extraction apparatus may include a user interface unit for receiving, from a user, an input to adjust a parameter for extracting coffee, wherein the user interface unit may include a first interface for receiving, from the user, an input of a first time period required to wet a puck contained in a portafilter of the coffee extraction apparatus using a fluid; a second interface for receiving, from the user, an input of a target pressure applied to the puck so as to extract coffee; and a third interface for receiving, from the user, an input of a second time period required to reach the target pressure.

### TECHNICAL FIELD

The present disclosure relates to a coffee extraction apparatus, and specifically, to a coffee extraction apparatus that can extract coffee with constant flavor and aroma.

### BACKGROUND ART

Coffee can be extracted by tamping ground coffee beans contained in a portafilter, mounting the portafilter to a coffee extraction apparatus, and then applying pressure to the ground coffee beans. In order to keep the flavor and aroma of coffee constant, the pressure applied to the ground coffee beans should be kept constant while the coffee is being extracted. That is, keeping the coffee extraction pressure constant may be an important factor in maintaining the flavor and aroma of coffee.

Coffee extraction apparatuses of the related art can adjust an extraction pressure for extracting coffee by measuring a pressure generated from a pressure unit that generates pressure. However, in this case, even when the pressure measured at the pressure unit is measured to have reached a pressure set by the user, a pressure reached in an extraction unit where coffee is actually extracted may not have reached the pressure set by the user.

For example, the pressure actually applied to the ground coffee beans may not reach the pressure set by the user, depending on various factors such as the amount, grinding degree, freshness, or a tamping state of ground coffee beans.

In this regard, Korean Patent Application Publication No. 10-2011-0045028 has been suggested.

### DISCLOSURE

### Technical Problem

The present disclosure has been made in view of the above-described situations of the related art and is to provide a coffee extraction apparatus that can maintain an extraction pressure constant.

The technical problems addressed by the present disclosure are not limited to the problems described above, and other problems not described will be apparently understood by one skilled in the art from the following description.

### Technical Solution

According to an exemplary embodiment of the present disclosure for solving the problems described above, a coffee extraction apparatus is disclosed. The coffee extraction apparatus may include a user interface unit configured to receive, from a user, an input to adjust a parameter for extracting coffee, wherein the user interface unit may include a first interface for receiving, from the user, an input of a first time period required to wet a puck contained in a portafilter of the coffee extraction apparatus using a fluid; a second interface for receiving, from the user, an input of a target pressure applied to the puck so as to extract coffee; and a third interface for receiving, from the user, an input of a second time period required to reach the target pressure.

In addition, the user interface unit may be configured, when the inputs of the target pressure and the second time period are received from the user, to display a result of expecting a change in pressure applied to the puck during the second time period so as to reach the target pressure in a graph format.

In addition, the user interface unit may further include a fourth interface for receiving, from the user, an input of a pressure applied to the puck during the first time period.

In addition, the coffee extraction apparatus may further include an extraction unit including a head configured to mount the portafilter thereto and form a space with the portafilter; a pressure unit configured to apply a pressure to the extraction unit; a first sensing unit configured to sense a pressure applied to an inside of the extraction unit; and a control unit configured to control an operation of the pressure unit such that the first pressure reaches the target pressure, based on the target pressure and the first pressure sensed by the first sensing unit.

In addition, the head may include a first flow channel connected to the head at one side and opening at the other side; a second flow channel into which a fluid discharged from the pressure unit is to flow; and a third flow channel formed symmetrically with the second flow channel with respect to the first flow channel, the fluid discharged from the pressure unit flowing into the third flow channel.

In addition, the pressure unit may include a cylinder filled with the fluid; a piston configured to apply a pressure to the fluid as it moves inside the cylinder; and a stepper motor configured to move the piston under control of the control unit.

In addition, the pressure unit may further include at least one second sensing unit configured to sense a position of the piston, and the control unit may be configured to control the stepper motor to move the piston based on the position of the piston sensed by the at least one second sensing unit.

In addition, the at least one second sensing unit may include a first sub-sensing unit configured to sense whether one end of the piston has reached a first inner wall of the cylinder and a second sub-sensing unit configured to sense whether the other end of the piston has reached a second inner wall of the cylinder facing the first inner wall.

In addition, the piston may include a first part for forming a first region of the piston; a second part coupled to the first part to form an outer shape of the piston; and a Glyd ring coupled between the first part and the second part.

In addition, another exemplary embodiment of the present disclosure provides a computer program stored on a computer-readable storage medium, wherein the computer program, when executed in one or more control units, causes a method for extracting coffee to be performed, the method including: receiving, from a user, an input of a first time period required to wet a puck contained in a portafilter of a coffee extraction apparatus using a fluid; receiving, from the user, an input of a target pressure applied to the puck so as to extract coffee; receiving, from the user, an input of a second time period required to reach the target pressure; and allowing the coffee extraction apparatus to extract coffee based on the first time period, the target pressure, and the second time period.

Further, still another exemplary embodiment of the present disclosure provides a coffee extraction method performed by a coffee extraction apparatus including at least one control unit, the method including: receiving, from a user, an input of a first time period required to wet a puck contained in a portafilter of the coffee extraction apparatus using a fluid; receiving, from the user, an input of a target pressure applied to the puck so as to extract coffee; receiving, from the user, an input of a second time period required to reach the target pressure; and allowing the coffee extraction apparatus to extract coffee based on the first time period, the target pressure, and the second time period.

The technical solutions obtainable in the present disclosure are not limited to the solutions described above, and other solutions not described will be apparently understood by one skilled in the art from the following description.

### Advantageous Effects

According to some exemplary embodiments of the present disclosure, it is possible to provide the coffee extraction apparatus that can maintain an extraction pressure constant.

The effects obtainable in the present disclosure are not limited to the effects described above, and other effects not described will be apparently understood by one skilled in the art from the following description.

### DESCRIPTION OF DRAWINGS

Various aspects will now be described with reference to the drawings. Here, similar reference numerals will be used to collectively refer to similar constitutional elements. In the following exemplary embodiments, for the sake of description, a plurality of specific details will be presented to provide comprehensive understanding of one or more aspects. However, it will be apparent that such aspect(s) may be embodied without the specific details. In other examples, known structures and apparatuses are shown in the form of a block diagram to facilitate description of one or more aspects.

FIG. 1 is a block configuration diagram for illustrating an example of a coffee extraction apparatus according to some exemplary embodiments of the present disclosure.

FIG. 2 is a diagram for illustrating an example of a coffee extraction apparatus according to some exemplary embodiments of the present disclosure.

FIG. 3 is a diagram for illustrating an example of a piston according to some exemplary embodiments of the present disclosure.

FIG. 4 is a diagram for illustrating an example of a head according to some exemplary embodiments of the present disclosure.

FIG. 5 is a diagram for illustrating an example of a user interface unit according to some exemplary embodiments of the present disclosure.

FIG. 6 is a diagram for illustrating another example of a user interface unit according to some exemplary embodiments of the present disclosure.

FIG. 7 is a flowchart for illustrating an example of a coffee extraction method according to some exemplary embodiments of the present disclosure.

### BEST MODE

Various embodiments and/or aspects will be now disclosed with reference to the drawings. In the following description, multiple detailed matters will be disclosed to help comprehensive appreciation of one or more aspects. However, it will also be appreciated by one skilled in the art that such aspect(s) can be embodied without the detailed matters. In the following description and the accompanying drawings, specific exemplary aspects of one or more aspects will be described in detail. However, the aspects are exemplary and the various methods in principles of various aspects may be used in part and the descriptions are intended to include all of the aspects and equivalents thereof. Specifically, in “exemplary embodiment”, “example”, “aspect”, “illustration” and the like used in the present specification, it may not be construed that any aspect or design that will be described is more favorable or advantageous than other aspects or designs.

Hereinafter, the same reference numerals refer to the same or similar constitutional elements regardless of drawing numerals, and overlapping descriptions thereof will be omitted. In addition, in describing an embodiment disclosed in the present specification, a detailed description of related known technologies will be omitted if it is determined that the detailed description makes the gist of the embodiment of the present specification unclear. Further, the accompanying drawings are only for easily understanding the exemplary embodiment disclosed in the present specification and the technical spirit disclosed by the present specification is not limited by the accompanying drawings.

Although the terms “first”, “second”, and the like are used for describing various devices or constitutional elements, these devices or constitutional elements are not limited by these terms. These terms are merely used for distinguishing one device or constitutional element from another device or constitutional element. Therefore, a first device or constitutional element described below may also be a second device or constitutional element in the technical spirit of the present invention.

Unless otherwise defined, all terms (including technical and scientific terms) used in the present specification may be used as the meaning that may be commonly understood by one skilled in the art to which the present disclosure belongs. In addition, terms defined in commonly used dictionaries should not be interpreted in an idealized or excessive sense unless defined explicitly and specially.

In addition, the term “or” is intended to mean an inclusive “or” rather than an exclusive “or”. That is, unless otherwise specified or clear from the context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” used in the present specification designates and includes all available combinations of one or more items among enumerated related items.

In addition, the terms “comprise” and/or “comprising” mean that a corresponding feature and/or constitutional element is present but should not be understood as excluding the presence or addition of one or more other features, constitutional elements, and/or groups thereof. Further, unless otherwise specified or in cases where it is not clear from the context to designate a singular form, the singular form in the present specification and claims should be interpreted as meaning “one or more” in general.

In addition, the terms “information” and “data” used herein may often be used interchangeably.

The description “a constitutional element or layer is “on” another constitutional element or layer” includes all of cases where the constitutional element or layer is formed directly on the other constitutional element or layer, and where another constitutional element or layer is interposed therebetween. In contrast, the description “a constitutional element is “directly on” another constitutional element refers to a case where there is no intervening constitutional element or layer present.

Spatially relative terms, such as “below”, “beneath”, “lower”, “above” and “upper” may be used herein to easily describe the relationship of one constitutional element to other constitutional element(s) as illustrated in the drawings. It should be understood that the spatially relative terms are intended to encompass different orientations of a device in use or operation, in addition to the orientation depicted in the drawings.

For example, a constitutional element described as “below” or “beneath” another constitutional element could be placed “above” another constitutional element if the constitutional element shown in the drawing is turned over. Thus, the exemplary term “below” or “beneath” may encompass both orientations of “above” and “below” or “beneath”. The constitutional element may also be oriented in different directions, and the spatially relative descriptors used herein may be interpreted according to the orientations.

When it is mentioned that a certain constitutional element is “connected” or “coupled” to another constitutional element, it should be understood that the certain constitutional element may be directly connected or coupled to the other constitutional element or another intervening constitutional element may be located therebetween. Conversely, when a constitutional element is referred to as being “directly connected” or “directly coupled” to another constitutional element, it is to be understood that there is no intervening constitutional element present.

The suffixes “module” and “unit” or “part” for constitutional elements used in the following description are given or used interchangeably only for ease of writing the specification, and thus do not themselves have distinct meanings or roles.

Objects and advantages of the present disclosure and technical elements for accomplishing the objects and advantages will be apparent by referring to embodiments described below in detail in connection with the accompanying drawings. In describing the present disclosure, when the detailed description of the known functions or configurations is determined as unnecessarily obscuring the gist of the present invention, the detailed description will be omitted. In addition, terms described below are defined in consideration of functions in the present disclosure and may be changed depending on a user, the intent of an operator, a custom, or the like.

However, the present disclosure is not limited to the following embodiments and may be implemented in various forms. These embodiments are provided only to make the present disclosure complete and to fully inform one skilled in the art of the scope of the disclosure, and the present disclosure is only defined by the scope of the claims. Therefore, the definition should be made based on the contents throughout the present specification.

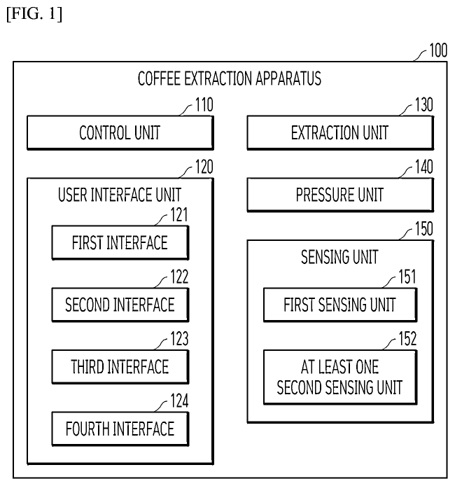

In the present disclosure, a coffee extraction apparatus may receive, from a user, an input to adjust a parameter for extracting coffee via a user interface (user interface) unit. A user interface in the present disclosure may be used to represent a means for mediating interaction between the coffee extraction apparatus and the user. Such a user interface may be output, for example, on a display unit of the coffee extraction apparatus. Types of the parameter may include, for example, a target pressure applied to a puck and a time required to reach the target pressure applied to the puck. Here, the puck may be understood to have the same or similar meaning as or to the ground coffee beans described in Background Art. Specifically, the ground coffee beans contained in the portafilter may be wetted by a fluid flowing into an extraction unit. In this case, a shape of the wetted ground coffee beans is similar to the puck used in ice hockey, so the wetted ground coffee beans are also called a puck or coffee puck. The coffee extraction apparatus receiving the target pressure via the user interface unit can apply a pressure to the puck through the pressure unit. Coffee extraction apparatuses of the related art can sense a pressure generated in the pressure unit and recognize whether the pressure generated in the pressure unit has reached the target pressure. However, even when the pressure generated in the pressure unit has reached the target pressure, the pressure actually applied to the puck may be different from the target pressure. Accordingly, a problem may arise where coffee is extracted that does not meet the flavor and aroma that the user expects. On the other hand, the coffee extraction apparatus according to an exemplary embodiment of the present disclosure can sense the pressure applied to the puck and determine whether the pressure applied to the puck has reached the target pressure input from the user. Hereinafter, a coffee extraction apparatus according to an exemplary embodiment of the present disclosure will be described with reference to FIGS. 1 to 7.

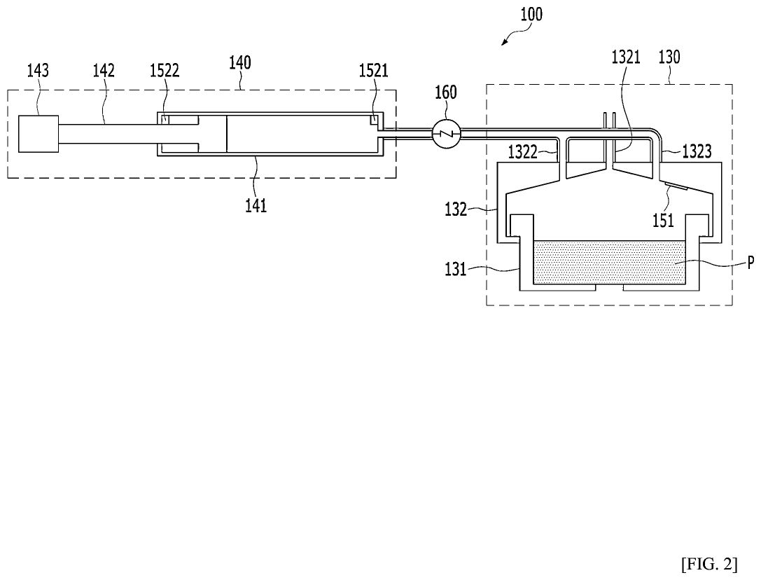

FIG. 1 is a block configuration diagram for illustrating an example of a coffee extraction apparatus according to some exemplary embodiments of the present disclosure. FIG. 2 is a diagram for illustrating an example of a coffee extraction apparatus according to some exemplary embodiments of the present disclosure.

Referring to FIG. 1, a coffee extraction apparatus 100 may include a control unit 110, a user interface unit 120, an extraction unit 130, a pressure unit 140, and a sensing unit 150. However, since the above-described constitutional elements are not essential to implement the coffee extraction apparatus 100, the coffee extraction apparatus 100 may include more or fewer constitutional elements than those listed above.

The control unit 110 may control overall operations of the coffee extraction apparatus 100. The control unit 110 may provide or process appropriate information or functions by processing signals, data, information, and the like input via the user interface unit 120 or by running an application program stored in a memory.

In the present disclosure, the control unit 110 may control an operation of the pressure unit 140.

Specifically, the pressure unit 140 may include a stepper motor for moving a piston located inside a cylinder to apply pressure to the extraction unit 130. The control unit 110 may control the pressure applied to the extraction unit 130 by controlling the stepper motor. The stepper motor may be a motor that can divide rotation of a rotor into a number of steps. The control unit 110 can adjust the pressure applied to the extraction unit 130 by controlling the rotation steps of the stepper motor.

According to some exemplary embodiments of the present disclosure, when a target pressure is input from a user, the control unit 110 may control the operation of the pressure unit 140 such that a first pressure reaches the target pressure, based on the target pressure and the first pressure sensed by the first sensing unit 151. The target pressure is a pressure applied to the puck so as to extract coffee and may be a parameter input by the user. The first sensing unit 151 may be a module that is provided inside the extraction unit 130 where the puck is contained and senses the first pressure applied to the inside of the extraction unit 130.

Specifically, when the control unit 110 controls the pressure unit 140 so that the target pressure input from the user can be discharged from the pressure unit 140 using only the target pressure, the actual pressure reached in the extraction unit 130 may be different from the pressure discharged from the pressure unit 140. This is because internal factors such as a type of coffee beans, freshness of ground coffee beans, an amount of ground coffee beans, a grinding degree of ground coffee beans, a tamping state of ground coffee beans, and a state of piping, and external factors such as a temperature and an environment can affect the pressure applied to the extraction unit 130. Therefore, the control unit 110 may compare the target pressure and the first pressure inside the extraction unit 130 sensed by the first sensing unit 151 and control the operation of the pressure unit 140 so that the first pressure reaches the target pressure. Accordingly, the coffee extraction apparatus 100 can extract coffee with the flavor and aroma desired by the user.

The user interface unit 120 may receive an input to adjust a parameter for extracting coffee from the user. The type of parameter may include, for example, a first time period required to wet the puck using a fluid, a pressure applied to the puck during the first time period, a target pressure applied to the puck so as to extract coffee, and a second time period required to reach the target pressure. In an exemplary embodiment, the user interface unit 120 may be used interchangeably with a display unit or output unit of the coffee extraction apparatus. Such a user interface unit 120 may further include an input unit for receiving a user input.

Specifically, the user interface unit 120 may include a first interface 121, a second interface 122, a third interface 123, and a fourth interface 124.

The first interface 121 may receive, from the user, an input of a first time period required to wet the puck contained in a portafilter of the coffee extraction apparatus 100 using a fluid. The portafilter may be a tool for coupling a filter basket containing ground coffee beans to the coffee extraction apparatus 100. Specifically, the portafilter may include a filter basket in which ground coffee beans are contained, a spout through which extracted coffee is discharged, and a grip part for the user to hold the portafilter. Hereinafter, the portafilter according to the present disclosure may be the same as the portafilter of the related art, so a detailed description thereof will be omitted.

The first time period may be a time period required to wet the puck contained in the portafilter using a fluid.

Specifically, in order to extract coffee with constant flavor, the user may tamp ground coffee beans contained in the portafilter so that the surface of the ground coffee beans is flat. The ground coffee beans in this state may be in a dry state without moisture. If a fluid with a pressure equal to or higher than a certain pressure reaches the ground coffee beans in a state in which the ground coffee beans are dry, the surface of the ground coffee beans may be cracked. If the surface of the ground coffee beans is cracked, the fluid that reaches the ground coffee beans during a coffee extraction process will not be able to permeate evenly into the ground coffee beans, and as a result, the flavor and aroma of the extracted coffee will not be constant or may be different from the flavor and aroma desired by the user. Therefore, the coffee extraction apparatus 100 can wet the ground coffee beans by receiving, from the user, an input of the first time period required to wet the ground coffee beans contained in the portafilter via the first interface 121.

In the present disclosure, the first time period presented by the coffee extraction apparatus 100 may be between 0 second and 20 seconds. The first interface 121 may receive an input of the first time period from the user, in a unit of a preset time. For example, the first interface 121 may receive an input of the first time period from the user, in a unit of 0.2 seconds.

The second interface 122 may receive, from the user, an input of the target pressure applied to the puck so as to extract coffee.

As an example, coffee extracted from the coffee extraction apparatus 100 may have different flavor and aroma depending on temperature, humidity, or fluid state even when the coffee is extracted with the same type of coffee beans, the same amount of ground coffee beans, and the same pressure. Therefore, the user can adjust the target pressure to extract coffee with the flavor and aroma desired by the user.

In the present disclosure, the target pressure provided by the coffee extraction apparatus 100 may be between 4 bar and 11 bar. The second interface 122 may receive an input of the target pressure from the user, in a unit of a preset pressure. For example, the second interface 122 may receive an input of the target pressure from the user, in a unit of 0.1 bar.

The third interface 123 may receive an input of the second time period required to reach the target pressure from the user.

For example, the time required for general coffee extraction apparatuses to extract coffee may be within 60 seconds. However, assuming that extraction of the coffee is completed within 60 seconds, the results of extraction may vary between the coffee extracted when the target pressure is applied to the puck for a period of 20 to 60 seconds and the coffee extracted when the target pressure is applied to the puck for a period of 40 to 60 seconds. Accordingly, the third interface 123 may receive an input of the second time period required to reach the target pressure from the user, and the user can extract coffee with the flavor and aroma desired by the user.

In the present disclosure, the second time period presented by the coffee extraction apparatus 100 may be between 4 seconds and 20 seconds. The third interface 123 may receive an input of the second time period from the user, in a unit of a preset time. For example, the third interface 123 may receive an input of the second time period from the user, in a unit of 0.2 second.

The fourth interface 124 may receive an input of the pressure applied to the puck during the first time period from the user.

Specifically, the ground coffee beans contained in the portafilter may be in a dry state without moisture. Accordingly, if a relatively high level of pressure with respect to the density of the surface of the ground coffee beans is applied to the ground coffee beans, the surface of the coffee bean may be cracked. On the other hand, if a relatively low level of pressure with respect to the density of the surface of the ground coffee beans is applied to the ground coffee beans, the fluid reaching the surface of the ground coffee beans may not permeate into the ground coffee beans. Therefore, the fourth interface 124 may receive an input of the pressure applied to the puck during the first time period from the user.

In the present disclosure, the user interface unit 120 may further include a fifth interface for adjusting an inflow amount of the fluid during the first time period.

According to some exemplary embodiments of the present disclosure, the user interface unit 120 may be a display device. The first interface 121 to the fourth interface 124 may include an indicator. The indicator may be a region within the interface that provides information to the user and in which a preset operation is performed based on a touch input from the user.

In the present disclosure, the first interface 121 to the fourth interface 124 may include mechanical input means (or mechanical keys, for example, knobs, buttons, dome switches, jog wheels, jog switches, and the like).

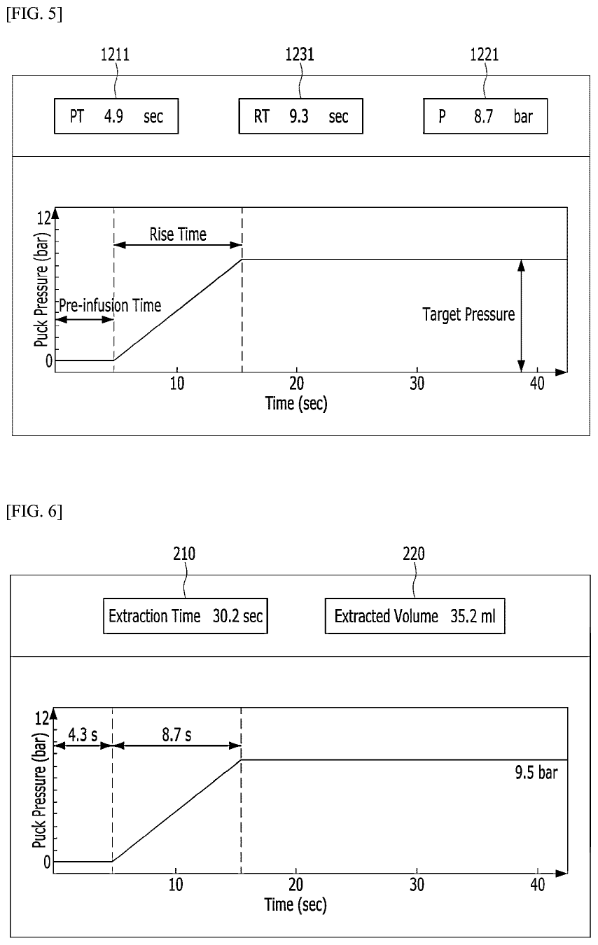

According to some exemplary embodiments of the present disclosure, when inputs of the target pressure and second time period are received from the user, the user interface unit 120 may display a result of expecting a change in pressure applied to the puck during the second time period so as to reach the target pressure in a graph format. Below, the expected result displayed on the user interface unit 120 will be described with reference to FIG. 5.

According to some exemplary embodiments of the present disclosure, when extraction of coffee is completed based on the first time period, target pressure, and second time period, the user interface unit 120 may display an extracted result.

For example, the user interface unit 120 may display a time required to extract coffee or an amount of coffee extracted. Below, the extraction result displayed on the user interface unit 120 will be described with reference to FIG. 6.

The extraction unit 130 may extract coffee from the puck contained in the portafilter.

Specifically, referring to FIG. 2, the extraction unit 130 may include a portafilter 131 and a head 132.

The portafilter 131 may be a member in which ground coffee beans or a puck (P) is contained by the user.

The head 132 may mount the portafilter 131 to a lower part thereof, forming a space with the portafilter 131.

In the present disclosure, the head 132 may include a first flow channel 1321, a second flow channel 1322, and a third flow channel 1323.

The first flow channel 1321 may be a flow channel that is connected to the head 132 at one side and opens at the other side. The first flow channel 1321 may be a flow channel through which a fluid introduced into the inside of extraction unit 130 and air bubbles mixed with the fluid are discharged. If air bubbles are present inside the extraction unit 130 during the coffee extraction process, the air bubbles may crack the surface of the puck (P). In order to prevent this, the head 132 is provided with the first flow channel 1321 to remove air bubbles present inside the extraction unit 130.

As an example, when the user interface unit 120 receives an input of the first time period from the user, the control unit 110 may control the pressure unit 140 to introduce a fluid into the extraction unit 130. If an amount of fluid flowing into the extraction unit 130 is greater than the space inside the extraction unit 130, the fluid may be discharged to the outside through the first flow channel 1321. As the fluid introduced into the extraction unit 130 is discharged to the outside through the first flow channel 1321, the air bubbles introduced into the extraction unit 130 may also be discharged.

According to some exemplary embodiments of the present disclosure, the first flow channel 1321 may be provided with a valve and a third sensing unit. The valve may be a value that is opened to discharge the fluid or closed to prevent the fluid from being discharged under control of the control unit 110. The third sensing unit may sense whether a fluid flows into the first flow channel 1321. When it is sensed through the third sensing unit that a fluid has flowed into the first flow channel 1321, the control unit 110 may close the valve so that the fluid is not discharged from the extraction unit 130.

The second flow channel may be a flow channel into which the fluid discharged from the pressure unit 140 flows. The third flow channel 1323 may be a flow channel that is formed symmetrically with the second flow channel 1322 with respect to the first flow channel 1321 and into which the fluid discharged from the pressure unit 140 flows.

The head provided to coffee extraction apparatuses of the related art may have one flow channel into which a fluid flows. Accordingly, the ground coffee beans contained in the portafilter may not be evenly wetted. In addition, if pressure is applied to the inside of the extraction unit through only one flow channel even during the coffee extraction process, the fluid permeating into the inside of the puck may be directed to only one side.

On the other hand, the head 132 according to the present disclosure may include the second flow channel 1322 and the third flow channel 1323 formed symmetrically with the second flow channel 1322 with respect to the first flow channel 1321. Accordingly, the ground coffee beans contained in the portafilter 131 can be evenly wetted, and the fluid can evenly permeate into the puck (P) even during the coffee extraction process.

According to some exemplary embodiments of the present disclosure, a needle valve may be provided in the fourth flow channel through which a fluid is delivered to the first flow channel 1321 and the third flow channel 1323. The needle valve may be a valve that can adjust a flow rate or fluid pressure by adjusting a degree of blocking the fourth flow channel. The user can also adjust the pressure applied to the extraction unit 130 by adjusting the needle valve. Alternatively, when the needle valve is an electric valve, the control unit 110 may control the pressure applied to the extraction unit 130 by controlling the needle valve.

In the present disclosure, the control unit 110 may control the pressure unit 140 so that even when a diameter of the fourth flow channel is narrowed or widened by the needle valve, a constant pressure is applied to the extraction unit 130 regardless of the narrowed first diameter and the widened second diameter.

Specifically, the needle valve may narrow the diameter of the fourth flow channel to a first diameter under the user's control. Accordingly, a pressure drop may occur in the fluid discharged from the pressure unit 140 as the fluid passes through the needle valve. However, the operation of the control unit 110 to control the pressure of the fluid discharged from the pressure unit 140 may be determined based on a first pressure sensed by the first sensing unit 151. Therefore, the control unit 110 may control the pressure unit 140 so that the pressure applied to the extraction unit 130 reaches the target pressure input by the user, regardless of whether the pressure of the fluid passing through the needle valve increases or decreases. Accordingly, even when an end portion of a plunger (or stem) of the needle valve is worn, the control unit 110 can ensure that the pressure applied to the extraction unit 130 reaches the target pressure.

According to some exemplary embodiments of the present disclosure, an inner upper surface of the head 132 may be formed in a conical shape.

Specifically, the head 132 may include a first inclined surface extending from a first inner surface to one side of the first flow channel 1321. The first inclined surface may be an inclined surface provided with the second flow channel 1322. The head 132 may include a second inclined surface extending from a second inner surface facing the first inner surface to one side of the first flow channel 1321. The second inclined surface may be an inclined surface provided with the third flow channel 1323. As the inner upper surface of the head 132 is formed in a conical shape, air bubbles present inside the extraction unit 130 can be completely discharged to the outside.

As an example, because air bubbles have a lower density than water, which is a fluid in the present disclosure, the air bubbles can rise to the surface of the water. However, assuming that the inner upper surface of the head 132 has a flat shape, not the conical shape, the water present inside the extraction unit 130 may be first discharged to the outside through the first flow channel 1321 before the air bubbles are discharged to the outside through the first flow channel 1321. If the water is first discharged to the outside through the first flow channel 1321, the air bubbles may not be discharged to the outside and may remain inside the water. When the pressure unit 140 applies pressure to the puck (P) so as to extract coffee, the air bubbles along with the water may reach the puck (P) because the air bubbles are present inside the water. If the inside of the extraction unit 130 is fully filled with only water, even when the pressure unit 140 applies pressure to the puck (P), the phenomenon that the puck (P) is cracked may not occur because the fluid in the extraction unit 130 is in a stable state. On the other hand, if the air bubbles are present, the puck (P) may be cracked due to the air bubbles or the fluid causing irregular movement due to the air bubbles. In order to prevent this, the inner upper surface of the head 132 in the present disclosure may be formed in a conical shape.

The pressure unit 140 may apply pressure to the extraction unit 130. The pressure unit 140 may be a linear actuator that physically operates under control of the control unit 110.

The pressure unit 140 may include a cylinder 141, a piston 142, and a stepper motor 143.

The cylinder 141 may be filled with a fluid through a flow channel connected to a water supply. The cylinder 141 may be filled with a fluid through a flow channel connected to a water tank (not shown).

Specifically, when the cylinder 141 is directly supplied with a fluid through a flow channel connected to a water supply, a large number of air bubbles may be generated inside the cylinder 141. In order to prevent this, the fluid introduced into the coffee extraction apparatus 100 may be first stored in the water tank before filling the inside of the cylinder 141.

The water tank may include a floating valve and a discharge part for discharging and delivering a fluid to the cylinder 141. The floating valve may be a valve that is closed or opened based on an amount of the fluid filled inside the water tank. As an example, when the inside of the water tank is fully filled with the fluid, the floating valve may be closed so that no more fluid flows into the water tank. The discharge part is provided at a lower end portion of the water tank and can discharge the fluid from the water tank so that the inside of the cylinder 141 can be filled with the fluid. As the discharge part is provided at the lower end portion of the water tank, air bubbles that may be present inside the water tank may not be introduced into the cylinder 141.

As the piston 142 moves inside the cylinder 141, pressure may be applied to the fluid filled inside the cylinder 141. For example, the piston 142 may move in a direction in which a flow channel is present inside the cylinder 141, thereby applying pressure to the fluid filled inside the cylinder 141.

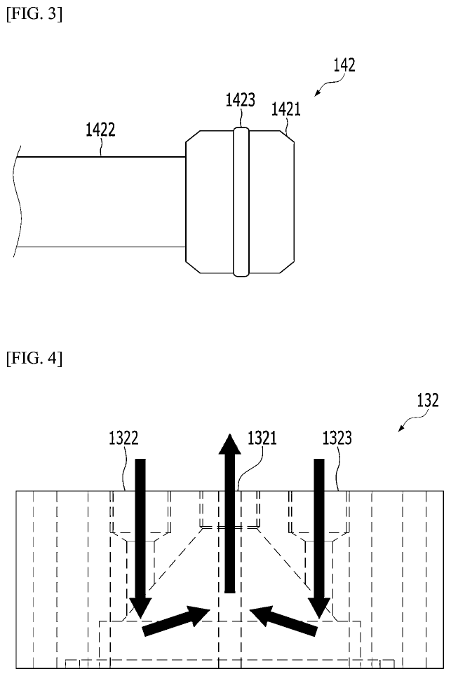

According to some exemplary embodiments of the present disclosure, the piston 142 may include a Glyd ring (or step seal). The Glyd ring may be a member for sealing so that the fluid does not move in a direction opposite to a moving direction of the piston 142 when the piston 142 pushes the fluid inside the cylinder 141. The Glyd ring may include a rubber O-ring coupled to the piston 142 so as to surround the piston 142 and a plastic seal that is formed to surround the O-ring and rubs against the inside of the cylinder 141. Since the seal generally rubs against the inside of the cylinder 141, the seal may be made of a plastic material so as to prevent wear. Accordingly, the user may experience difficulty in coupling the Glyd ring to the piston 142. In order to solve this problem, the piston 142 in the present disclosure may be formed of two parts to facilitate the coupling of the Glyd ring. Below, the piston portion 142 according to the present disclosure will be described later with reference to FIG. 3.

The stepper motor 143 can move the piston 142 under control of the control unit 110. The stepper motor 143 may be a motor that can divide rotation of a rotor into a large number of steps. The control unit 110 can move the piston 142 by controlling the rotation steps of the stepper motor 143, and accordingly adjust the pressure applied to the extraction unit 130.

According to some exemplary embodiments of the present disclosure, the fluid filled in the cylinder 141 through the water supply may be water at room temperature. The coffee extraction apparatus 100 may extract coffee using water at room temperature filled in the cylinder 141.

In the case of coffee extraction apparatuses of the related art, pressure can be applied to the pressure unit using steam generated by boiling water using a boiler. Accordingly, additional power may be consumed so as to drive the boiler and boil water. On the other hand, the coffee extraction apparatus 100 according to an exemplary embodiment of the present disclosure can directly apply pressure to the fluid present inside the cylinder 141 through the piston 142. Therefore, the coffee extraction apparatus 100 can extract coffee regardless of the temperature of the fluid filled in the cylinder 142.

The sensing unit 150 may include a first sensing unit 151 and at least one second sensing unit 152 for sensing information inside the coffee extraction apparatus 100.

The first sensing unit 151 is provided inside the extraction unit 130 and can sense the pressure applied to the inside of the extraction unit 130. The first sensing unit 151 may be a pressure sensor that can sense pressure.

As an example, the stepper motor 143 of the pressure unit 140 may apply pressure to the inside of the extraction unit 130 by moving the piston 142 under control of the control unit 110. When pressure is applied to the inside of the extraction unit 130, the first sensing unit 151 may sense the pressure applied to the inside of the extraction unit 130.

In some exemplary embodiments, when a first pressure applied to the inside of the extraction unit 130 is sensed by the first sensing unit 151, the control unit 110 may compare the first pressure and the target pressure input from the user through the user interface unit 120. The control unit 110 may control the stepper motor 143 so that the first pressure reaches the target pressure.

At least one second sensing unit 152 may be provided inside the pressure unit 140 to sense a position of the piston 142. At least one second sensing unit 152 may be a switch-type sensor with a spring attached. At least one second sensing unit 152 may be provided inside the pressure unit 140 and sense whether the piston 142 has reached an inner wall of the cylinder 141. The control unit 110 may control the stepper motor 143 to move the piston 142 based on the position of the piston 142 sensed by at least one second sensing unit 152.

As an example, at least one second sensing unit 152 may include a first sub-sensing unit 1521 and a second sub-sensing unit 1522.

The first sub-sensing unit 1521 may be provided on a first inner wall of the cylinder 141 located in a first direction in which the piston 142 moves to push the fluid, and sense whether one end of the piston 142 has reached the first inner wall of the cylinder 141. If the piston 142 moves further in the first direction by the stepper motor 143 even though the piston 142 has reached the first inner wall of the cylinder 141, the piston 142 and the cylinder 141 may be damaged. Therefore, the control unit 110 may control the stepper motor 143 to move the piston 142 based on the position of the piston 142 sensed by the first sub-sensing unit 1521.

The second sub-sensing unit 1522 may be provided on a second inner wall facing the first inner wall of the cylinder 141 and sense whether the other end of the piston 142 has reached the second inner wall of the cylinder 141.

The first sub-sensing unit 1521 and the second sub-sensing unit 1522 may also be provided on the piston 142. As an example, the first sub-sensing unit 1521 may be provided at one end of the piston 142 and sense whether one end of the piston 142 has reached the first inner wall of the cylinder 141. The second sub-sensing unit 1522 may be provided at the other end of the piston 142 and sense whether the other end of the piston 142 has reached the second inner wall of the cylinder 141.

According to some exemplary embodiments of the present disclosure, the coffee extraction apparatus 100 may further include a pump. The pump may cause the fluid to flow into the cylinder 141 when the piston 142 moves in a second direction opposite to the first direction. Accordingly, the piston 142 can be quickly moved in the second direction.

As an example, when extraction of coffee is completed, the piston 142 may be positioned close to the first inner wall of the cylinder 141. This may be because the piston 142 should move in the first direction so as to apply pressure to the extraction unit 130 by pushing the fluid. When extraction of coffee is completed, the piston 142 may need to move in the second direction so as to prepare for next coffee extraction. Along with the operation of the stepper motor 143 to move the piston 142 in the second direction, the pump may fill the fluid in the cylinder 141. Accordingly, the piston 142 can be quickly moved in the second direction. According to an embodiment of the present disclosure described above, a technical effect of reducing a waiting time in a situation where coffee is consecutively extracted can be achieved.

In the present disclosure, a check valve 160 may be further included in a flow channel through which the fluid discharged from the pressure unit 140 is delivered to the extraction unit 130. The check valve may be a valve for preventing the fluid from moving in a direction opposite to a direction designed by the user. As the check valve is provided in the flow channel, a phenomenon that the fluid moves from the extraction unit 130 to the pressure unit 140, contrary to the user's design, can be prevented. According to an exemplary embodiment of the present disclosure described above, a technical effect of preventing contamination of the pressure unit due to the inflow of ground coffee beans or the like by the backflow prevention function of the check valve 160 can be achieved.

According to the above-described configuration, the coffee extraction apparatus 100 may include the user interface unit 120 for receiving, from the user, an input to adjust a parameter for extracting coffee. Although the flavor and aroma of coffee change delicately depending on extraction conditions, in the case of coffee extraction apparatuses of the related art, it is almost impossible or difficult for the user to adjust the parameter for extracting coffee. On the other hand, in the case of the coffee extraction apparatus 100 according to an exemplary embodiment of the present disclosure, the first interface 121 to the fourth interface 124 are provided to the user so that the user can extract coffee with the flavor and aroma desired by the user.

In addition, even if the user determines the pressure applied to the extraction unit 130 through the user interface unit 120, since the coffee extraction apparatuses of the related art measure the pressure of the fluid discharged from the pressure unit, the pressure actually applied to the extraction unit may be different from the pressure desired by the user. On the other hand, the coffee extraction apparatus 100 according to an exemplary embodiment of the present disclosure can control the operation of the pressure unit 140 so that the first pressure reaches the target pressure, based on the target pressure input from the user and the first pressure sensed by the first sensing unit 151 provided inside the extraction unit 130. Therefore, the coffee extraction conditions desired by the user can be accurately reflected.

According to some exemplary embodiments of the present disclosure, the piston 142 may be formed of two parts so as to facilitate assembly of the Glyd ring. Below, the piston 142 according to an exemplary embodiment of the present disclosure will be described with reference to FIG. 3.

FIG. 3 is a diagram for illustrating an example of a piston according to some exemplary embodiments of the present disclosure.

Referring to FIG. 3, the piston 142 may include a first part 1421, a second part 1422, and a Glyd ring 1423.

The first part 1421 may form a first region of the piston 142. The first region may be a region including one end of the piston 142 in contact with the first inner wall of the cylinder 141.

The second part 1422 may be combined with the first part 1421 to form an outer shape of the piston. The second part 1422 may be a region including the other end of the piston 142 in contact with the second inner wall of the cylinder 141.

The first part 1421 and the second part 1422 may be fastened through screw coupling. As an example, the first part 1421 may be formed with an external thread for coupling to the second part 1422. The external thread may be formed to protrude from a central axis of the first part 1421 having a cylindrical shape toward the second part 1422. The second part 1422 may be formed with an internal thread for coupling to the first part 1421. The internal thread may be recessed so that the external thread of the first part 1421 can be inserted and fastened to a central axis of the second part 1422 having a cylindrical shape.

The Glyd ring 1423 may be coupled between the first part 1421 and the second part 1422.

Specifically, the Glyd ring 1423 may include a rubber O-ring coupled to the piston 142 so as to surround the piston 142 and a plastic seal that is formed to surround the O-ring and rubs against the inside of the cylinder 141. Since the seal is generally made of a plastic material, the user may experience difficulty in coupling the Glyd ring to the piston 142. Therefore, the piston 142 in the present disclosure may include the first part 1421 and the second part 1422 that can be disassembled/assembled with respect to the first part 1421. The user can assemble the Glyd ring 1423 by separating the first part 1421 and the second part 1422 of the piston 142. When the Glyd ring 1423 is assembled, the user can assemble the first part 1421 and the second part 1422. In this way, the user can easily couple the Glyd ring 1423 to the piston 142.

According to some exemplary embodiments of the present disclosure, the head 132 may include the second flow channel 1322 into which the fluid discharged from the pressure unit 140 flows and the third flow channel 1323 formed symmetrically with the second flow channel 1322 with respect to the first flow channel 1321, the fluid discharged from the pressure unit 140 flowing into the third flow channel 1323. Below, the head 132 according to an exemplary embodiment of the present disclosure will be described with reference to FIG. 4.

FIG. 4 is a diagram for illustrating an example of a head according to some exemplary embodiments of the present disclosure. The arrows in FIG. 4 may indicate the flow of fluid flowing into and out of the head 132.

Referring to FIG. 4, the head 132 may include the first flow channel 1321, the second flow channel 1322, and the third flow channel 1323.

The first flow channel 1321 may be a flow channel that is connected to the head 132 at one side and opens at the other side.

The second flow channel 1322 may be a flow channel into which the fluid discharged from the pressure unit 140 flows. The third flow channel 1323 may be a flow channel that is formed symmetrically with the second flow channel 1322 with respect to the first flow channel 1321 and into which the fluid discharged from the pressure unit 140 flows.

The head provided to coffee extraction apparatuses of the related art may have one flow channel into which a fluid flows. Accordingly, the ground coffee beans contained in the portafilter 131 may not be evenly wetted. In addition, if pressure is applied to the inside of the extraction unit through only one flow channel even during the coffee extraction process, the fluid permeating into the inside of the puck may be directed to only one side.

On the other hand, the head 132 according to the present disclosure may include the second flow channel 1322 and the third flow channel 1323 formed symmetrically with the second flow channel 1322 with respect to the first flow channel 1321. Accordingly, the ground coffee beans contained in the portafilter 131 can be evenly wetted, and the fluid can evenly permeate into the puck (P) even during the coffee extraction process.

According to some exemplary embodiments of the present disclosure, when inputs of the target pressure and second time period are received from the user, the user interface unit 120 may display a result of expecting a change in pressure applied to the puck during the second time period so as to reach the target pressure in a graph format. Below, the user interface unit 120 according to an exemplary embodiment of the present disclosure will be described with reference to FIG. 5.

FIG. 5 is a diagram for illustrating an example of a user interface unit according to some exemplary embodiments of the present disclosure. The x-axis of the user interface shown in FIG. 5 may represent time (Time (sec)), and the y-axis may represent pressure applied to the puck (Puck Pressure (bar)). The graph shown in FIG. 5 may be a graph showing a change in pressure over time.

Referring to FIG. 5, the user interface unit 120 may display a first indicator 1211 showing a first time period, a second indicator 1221 showing a target pressure, and a third indicator 1231 showing a second time period.

The user interface unit 120 may show the first time period in the form of a graph. As an example, the first time period input from the user via the first interface 121 may be 4.9 seconds. The pressure applied to the puck during the first time period input from the user via the fourth interface 124 may be 0 bar. The user interface unit 120 may express that a pressure of 0 bar is applied to the puck (P) during a first time period (Pre-infusion Time) in the form of a graph.

The user interface unit 120 may express a result of expecting a change in pressure applied to the puck (P) during the second time period (Rise Time) in the form of a graph. As an example, the target pressure input from the user via the second interface 122 may be 8.7 bar. The second time period (Rise Time) input from the user via the third interface 123 may be 9.3 seconds. The user interface unit 120 may express the pressure that changes from 0 bar, which is input via the fourth interface 124, to 8.7 bar, which is the target pressure, during the second time period (Rise Time) in the form of a graph.

As the first time period, the target pressure, the second time period, the result of expecting the change in pressure applied to the puck (P) during the second time period, and the like are displayed on the user interface unit 120, the user can appropriately adjust various factors for coffee extraction.

According to some exemplary embodiments of the present disclosure, when extraction of coffee is completed, the user interface unit 120 may display an extraction result. Below, the extraction result displayed on the user interface unit 120 will be described with reference to FIG. 6.

FIG. 6 is a diagram for illustrating another example of a user interface unit according to some exemplary embodiments of the present disclosure. The x-axis of the user interface shown in FIG. 6 may represent time (Time (sec)), and the y-axis may represent pressure applied to the puck (Puck Pressure (bar)). The graph shown in FIG. 6 may be a graph showing a change in pressure over time.

Referring to FIG. 6, the user interface unit 120 may display a fourth indicator 210 showing a time required to extract coffee and a fifth indicator 220 showing an amount of extracted coffee.

According to some exemplary embodiments of the present disclosure, the control unit 110 of the coffee extraction apparatus 100 may calculate an amount of extracted coffee based on a speed of the stepper motor 143.

Specifically, the control unit 110 may control the operation of the stepper motor 143 so that the first pressure reaches the target pressure, based on the target pressure and the first pressure sensed by the first sensing unit 151. When controlling the operation of the stepper motor 143, the control unit 110 may calculate a position of the rotor of the stepper motor 143 by integrating a rotation speed of the rotor of the stepper motor 143. The control unit 110 may calculate an amount of extracted coffee from the calculated position of the rotor.

For example, a change in position of the rotor may indicate a moving distance of the piston 142 within the cylinder 141. The moving distance of the piston 142 may be related to an amount by which the piston 142 pushes the fluid filled in the cylinder 141. Since the amount of fluid discharged from the cylinder 141 may be related to the amount of extracted coffee, the control unit 110 may calculate the amount of extracted coffee by controlling the operation of the stepper motor 143.

The user interface unit 120 may express the first time period (Pre-infusion time) actually spent in the operation of extracting coffee in the form of a graph. The user interface unit 120 may express the second time period (Rise time) actually spent in the operation of extracting coffee in the form of a graph. The user interface unit 120 may express the change in pressure actually applied to the puck (P) during the second time period (Rise Time) in the operation of extracting coffee in the form of a graph.

The first time period and the second time period actually spent to extract the coffee, as well as the pressure at which the coffee was actually extracted, the change in pressure applied to the puck (P) during the second time period, and the like may be displayed on the user interface unit 120, so that the user can appropriately adjust various factors for coffee extraction.

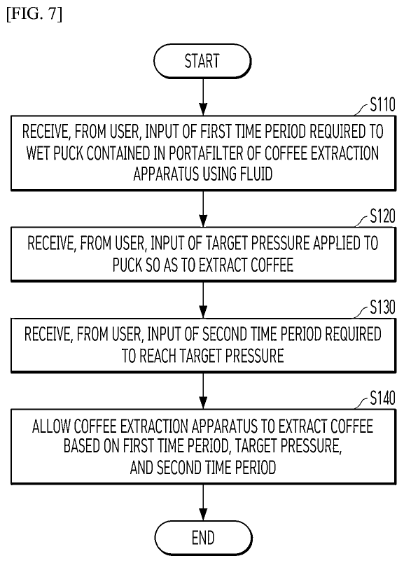

FIG. 7 is a flowchart for illustrating an example of a coffee extraction method according to some exemplary embodiments of the present disclosure. In order to avoid redundant descriptions of the previously described features among the technical features represented in FIG. 7, the previous descriptions will be referred to but omitted in FIG. 7.

Referring to FIG. 7, the first interface 121 of the user interface unit 120 may receive, from the user, an input of a first time period required to wet the puck (P) contained in the portafilter 131 of the coffee extraction apparatus 100 using a fluid (S110).

The second interface 122 may receive, from the user, an input of a target pressure applied to the puck (P) so as to extract coffee (S120).

The third interface 123 may receive, from the user, an input of a second time period required to reach the target pressure (S130).

The control unit 110 may allow the coffee extraction apparatus 100 to extract coffee based on the first time period, target pressure, and second time period (S140).

As an example, the control unit 110 may control the operation of the pressure unit 140 based on the first time period, target pressure, and second time period. The pressure unit 140 may extract coffee by applying the pressure determined by the control unit 110 to the extraction unit 130.

The description of the presented embodiments has been provided to allow anyone skilled in the art to use or embody the present disclosure. It will be apparent to one skilled in the art that various modifications may be made to the embodiments, and general principles defined herein may be applied to other embodiments without departing from the scope of the present disclosure. Therefore, the present disclosure is not limited to the embodiments presented herein and should be interpreted as having the broadest possible range that is consistent with the principles and novel features presented herein.

### MODE FOR INVENTION

As described above, the relevant content has been described in the best mode for carrying out the invention.

### INDUSTRIAL APPLICABILITY

The present disclosure can be applied to a coffee extraction apparatus, a system, and the like that can extract coffee with constant flavor and aroma.

1. A coffee extraction apparatus comprising:
a user interface unit output on a display unit of the coffee extraction apparatus configured to receive, from a user, an input to adjust a parameter for extracting coffee;
an extraction unit comprising a head configured to mount a portafilter thereto and form a space with the portafilter; and
a pressure unit configured to apply a pressure to the extraction unit by a piston configured to apply a pressure to a fluid as it moves inside a cylinder filled with the fluid;
wherein the user interface unit comprises:
a first interface for receiving, from the user, an input of a first time period required to wet a puck contained in a portafilter of the coffee extraction apparatus using a fluid;
a second interface for receiving, from the user, an input of a target pressure applied to the puck so as to extract coffee;
a third interface for receiving, from the user, an input of a second time period required to reach the target pressure; and
a fourth interface for receiving, from the user, an input of a pressure applied to the puck during the first time period; and
when the inputs of the target pressure and the second time period are received from the user, displays a result of expecting a change in pressure applied to the puck during the second time period so as to reach the target pressure in a graph format; and
wherein the piston comprises a member for sealing surrounds the piston so that the fluid does not move in a direction opposite to a moving direction of the piston.

2. (canceled)

3. (canceled)

4. The coffee extraction apparatus of claim 1, further comprising:
a first sensing unit configured to sense a pressure applied to an inside of the extraction unit; and
a control unit configured to control an operation of the pressure unit such that a first pressure reaches the target pressure, based on the target pressure and the first pressure sensed by the first sensing unit.

5. The coffee extraction apparatus of claim 4, wherein the head comprises:
a first flow channel connected to the head at one side and opening at the other side;
a second flow channel into which a fluid discharged from the pressure unit is to flow; and
a third flow channel formed symmetrically with the second flow channel with respect to the first flow channel, the fluid discharged from the pressure unit flowing into the third flow channel.

6. The coffee extraction apparatus of claim 4, wherein the pressure unit comprises:
a cylinder filled with the fluid;
a piston configured to apply a pressure to the fluid as it moves inside the cylinder; and
a stepper motor configured to move the piston under control of the control unit.

7. The coffee extraction apparatus of claim 6, wherein the pressure unit further comprises at least one second sensing unit configured to sense a position of the piston, and
wherein the control unit is configured to control the stepper motor to move the piston based on the position of the piston sensed by the at least one second sensing unit.

8. The coffee extraction apparatus of claim 7, wherein the at least one second sensing unit comprises a first sub-sensing unit configured to sense whether one end of the piston has reached a first inner wall of the cylinder and a second sub-sensing unit configured to sense whether the other end of the piston has reached a second inner wall of the cylinder facing the first inner wall.

9. The coffee extraction apparatus of claim 1, wherein the piston comprises:
a first part for forming a first region of the piston; and
a second part coupled to the first part to form an outer shape of the piston; and
wherein the member for sealing is coupled between the first part and the second part.

10. A computer program stored on a computer-readable storage medium, wherein the computer program, when executed in one or more control units, causes a method for extracting coffee to be performed, the method comprising:
applying, a pressure to an extraction unit comprising a head configured to mount a portafilter thereto and form a space with the portafilter, by a piston configured to apply a pressure to a fluid as it moves inside a cylinder filled with the fluid;
receiving, from a user, an input of a first time period required to wet a puck contained in a portafilter of a coffee extraction apparatus using a fluid;
receiving, from the user, an input of a target pressure applied to the puck in order to extract coffee;
receiving, from the user, an input of a second time period required to reach the target pressure;
receiving, from the user, an input of a pressure applied to the puck during the first time period; and
allowing the coffee extraction apparatus to extract the coffee based on the first time period, the target pressure, and the second time period;
when the inputs of the target pressure and the second time period are received from the user, displaying a result of expecting a change in pressure applied to the puck during the second time period so as to reach the target pressure in a graph format on a display unit, and
wherein the piston comprises a member for sealing surrounds the piston so that the fluid does not move in a direction opposite to a moving direction of the piston.

11. A coffee extraction method performed by a coffee extraction apparatus comprising at least one control unit and display unit, the method comprising:
applying, a pressure to an extraction unit comprising a head configured to mount a portafilter thereto and form a space with the portafilter, by a piston configured to apply a pressure to a fluid as it moves inside a cylinder filled with the fluid;
receiving, from a user, an input of a first time period required to wet a puck contained in a portafilter of a coffee extraction apparatus using a fluid;
receiving, from the user, an input of a target pressure applied to the puck in order to extract coffee;
receiving, from the user, an input of a second time period required to reach the target pressure;
receiving, from the user, an input of a pressure applied to the puck during the first time period; and
allowing the coffee extraction apparatus to extract the coffee based on the first time period, the target pressure, and the second time period; and
when the inputs of the target pressure and the second time period are received from the user, displaying a result of expecting a change in pressure applied to the puck during the second time period so as to reach the target pressure in a graph format, and
wherein the piston comprises a member for sealing surrounds the piston so that the fluid does not move in a direction opposite to a moving direction of the piston.
